(19) United States
(12) Patent Application Publication
(10) Pub. No.: US 2011/0253858 A1
(43) Pub. Date: Oct. 20, 2011

(54) JAMB BRACKET SYSTEM

(76) Inventors: Vern Scheuermann, Des Moines, IA (US); Margaret Scheuermann, Des Moines, IA (US)

(21) Appl. No.: 13/040,033

(22) Filed: Mar. 3, 2011

Related U.S. Application Data
(60) Provisional application No. 61/325,426, filed on Apr. 19, 2010.

(51) Int. Cl. F16M 13/02

(52) U.S. Cl. 248/223.41

(57) ABSTRACT

The jamb bracket system having a jamb bracket with a plate that is matingly received within a mounting plate groove. The jamb bracket has a pair of attachment plates for connection with a closure assembly. At least one screw is disposed through the jamb bracket and mounting plate to attach it to the door jamb. The mounting plate is made of a composite powdered aluminum that permits the mounting plate to break away from the door jamb when a predetermined load is placed on the plate.

### CROSS REFERENCE TO RELATED APPLICATION

This application claims the benefit of U.S. Provisional Application No. 61/325,426 filed Apr. 19, 2010.

### BACKGROUND OF THE INVENTION

This invention is directed toward a jamb bracket system, and more particularly to a breakaway jamb bracket system that reduces the potential for damage to a storm door.

Door jamb brackets are well-known in the art. While useful, conventional bracket systems make removal of a storm door difficult. In addition, because of a more rigid connection, when heavy wind acts upon the storm door, damage can occur to the storm door because the door does not easily breakaway from the bracket. Accordingly, a need exists in the art for a bracket that addresses these deficiencies.

An objective of the present invention is to provide a breakaway jamb bracket system that reduces damage to a storm door under excessive loads.

This and other objectives will be apparent to those skilled in the art based on the following written description.

### BRIEF SUMMARY OF THE INVENTION

A jamb bracket system that has a mounting plate with a groove on an inner surface that receives a jamb bracket. The jamb bracket has a plate and a pair of attachment plates for connection with a closure assembly. There is at least one screw disposed through the jamb bracket and mounting plate. The mounting plate is comprised of a composite powered aluminum that permits the plate to break away from a door jamb when a predetermined load is placed on the plate.

### BRIEF DESCRIPTION OF THE DRAWINGS

FIG. 1 is an exploded perspective view of a jamb bracket system;

FIG. 2 is a perspective view of a jamb bracket system;

FIG. 3 is a sectional view of a jamb bracket system;

FIG. 4 is a side plan view of a jamb bracket system;

FIG. 5 is a sectional view of a jamb bracket system; and

FIG. 6 is a sectional view of a jamb bracket system;

### DETAILED DESCRIPTION OF THE PREFERRED EMBODIMENT

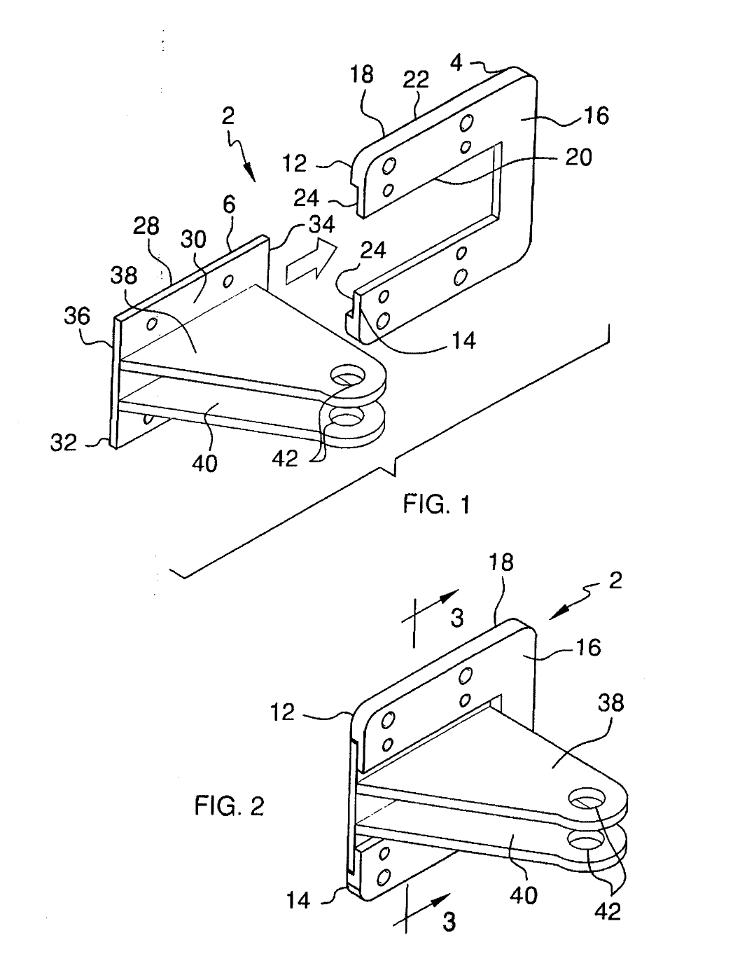

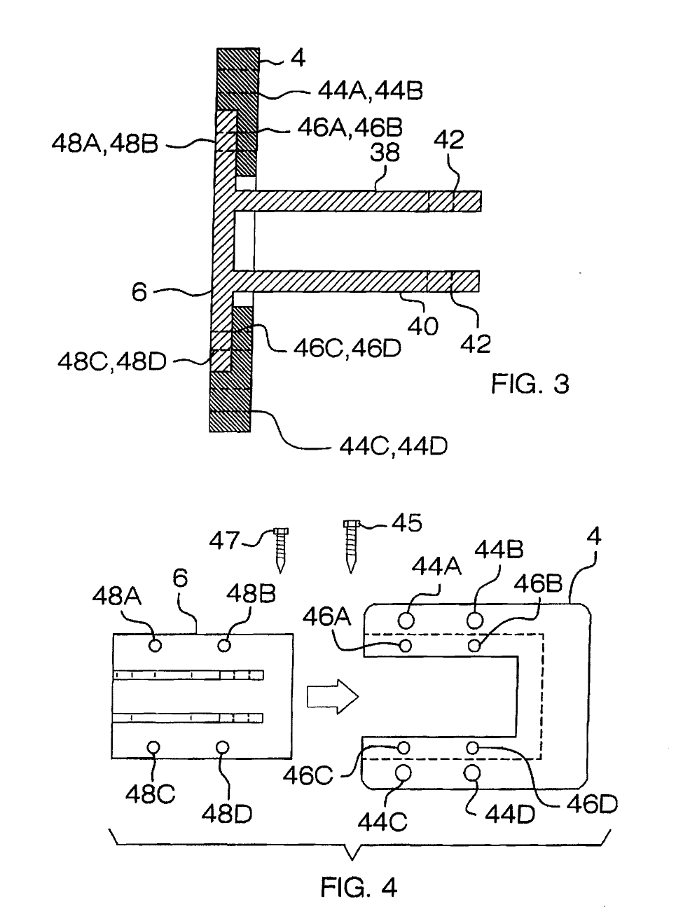

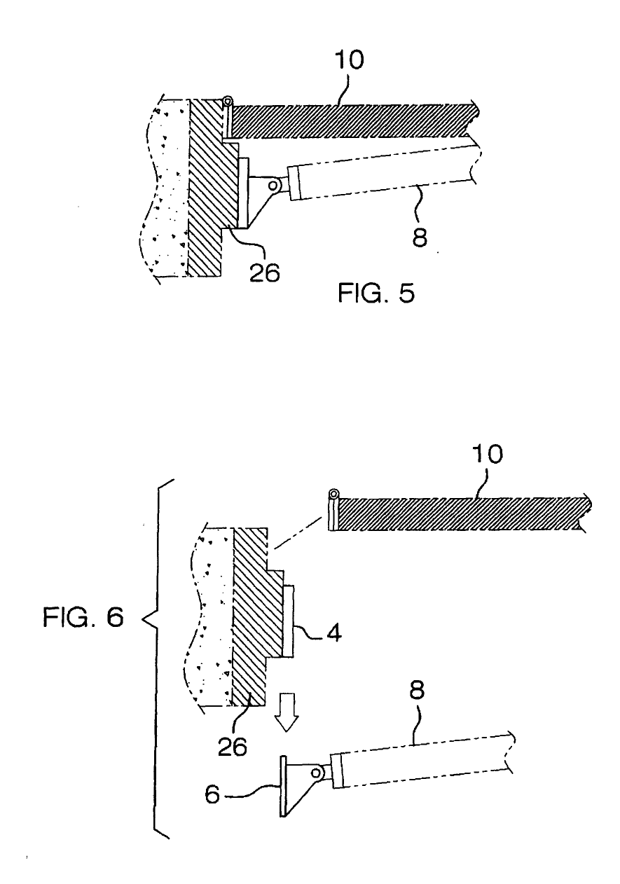

With reference now to the drawings, and in particular to FIGS. 1 through 6 thereof, a new jamb bracket system embodying the principles and concepts of the present invention and generally designated by the reference numeral 2 will be described.

As best illustrated in FIGS. 1 through 6, the jamb bracket system 2 comprises a mounting plate 4 and a jamb bracket 6. The jamb bracket system 2 itself is designed to be attached to a closer assembly 8, which is subsequently attached to a storm door 10.

The mounting plate 4 is U-shaped and has two ends comprising a first end 12 and a second end 14, and furthermore, has two surfaces comprising an outer surface 16 and an inner surface 18. The mounting plate 4 further includes an inner edge 20 and an outer edge 22. The mounting plate 4 further includes a groove 24 that is located on the inner surface 18 of the mounting plate 4. The groove 24 covers approximately half the surface area of the inner surface 18 of the mounting plate 4 and is located adjacent to the inner edge 20 of the mounting plate 4. The presence of the groove 24 essentially halves the thickness of the mounting plate 4 where the groove 24 is located. The groove 24 has both a length and a width. The mounting plate 4 is made of a composite powdered aluminum which permits the plate to break away like a sheer pin effect under excessive loads.

When placed against a door frame 26, the inner edge 20 of the mounting plate 4 is designed to be flush with the door frame 26. The area where the groove 24 is located, however, forms a small space in between the door frame 26 and the mounting plate 4.

The jamb bracket 6 comprises a flat plate 28 which is preferably rectangularly shaped. The flat plate 28 has two surfaces comprising a top surface 30 and a bottom surface 32, and furthermore, has two ends, a first end 34 and a second end 36. The flat plate 28 has a length and a width, with the length running from the first end 34 to the second end 36 of the flat plate 28.

A pair of attachment plates 38 and 40 are attached to the top surface of the flat plate 28, with these attachment plates 38 and 40 being parallel to one another. The plates 38 and 40 are designed to travel from the first end 34 to the second end 36 of the flat plate 28. Each plate 38 and 40 has a hole 42 that can be used for attachment of the closer assembly 8, with the closer assembly 8 being pivotally attached to the plates 38 and 40.

Once the mounting plate 4 has been appropriately attached to a door frame 26, the jamb bracket 6 can be removably attached to the mounting by inserting the flat plate 28 in between the mounting plate 4 and the door frame 26 with the bottom surface 32 of the flat plate 28 being flush against the door frame 26. To do this, the flat plate 28 is inserted lengthwise into the groove 24, allowing the plates 38 and 40 to extend outward in between the two ends of the mounting plate 4. The length and width of the flat plate 28 are the same as the length and width of the groove 24, and therefore, once the jamb bracket 6 has been fully inserted into the groove 24, the second end of the jamb bracket 6 is flush with the first end and second end of the mounting bracket 4 and the flat plate 28 is snugly located in between the mounting plate 4 and the door frame 26.

The mounting plate 4 itself has a plurality of screw holes that allow it to be properly fastened to a door frame 26. The plurality of screw holes includes a quartet of outer screw holes 44A, 44B, 44C, and 44D, and a plurality of inner screw holes 46A, 46B, 46C, and 46D. Furthermore, the jamb bracket 6 itself has four screw holes 48A, 48B, 48C, and 48D.

The outer screw holes 44A-44D are not located over an area of the mounting plate 4 where the groove 24 is located. Therefore, these screw holes are located in an area where the mounting plate 4 is at its thickest. A number of wood screws 45 are used for insertion through these screw holes 44A-44D and these are usually designed to be rather permanent, although they can be removed if needed.

The inner screw holes 46A-46D are located over an area of the mounting plate 4 where the groove 24 is located. When the jamb bracket 6 is completed inserted into the groove 24, the inner screw holes 46A-460 line up perfectly with the screw holes 48A-48D on the jamb bracket 6. At this point, a number of screws 47 can be used to secure the jamb bracket 6 to the mounting plate 4. Each screw 47 will be inserted through an inner screw hole on the mounting plate 4, through a screw hole on the jamb bracket 6, and then into the door frame 26 itself to secure these two components together. The screws 47 are preferably Allen hex set screws.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A jamb bracket system comprising:
a mounting plate having a groove in an inner surface;
a jamb bracket having a plate that is matingly received in the groove of the mounting plate;
said jamb bracket having a pair of attachment plates for connection with a closure assembly;
at least one screw disposed through the jamb bracket and mounting plate; and
wherein the mounting plate is composite powdered aluminum permitting the plate to break away when a predetermined load is placed on the plate.

2. The system of claim 1 wherein the mounting plate is U-shaped.

3. The system of claim 1 wherein when the jamb bracket is received by the mounting plate the jamb bracket and mounting plate are flush.
